(19) United States
(12) Patent Application Publication
(10) Pub. No.: US 2012/0162109 A1
(43) Pub. Date: Jun. 28, 2012

(54) DISPLAY APPARATUS

(75) Inventor: Kazuhiro SASAKI, Sagamihara-shi (JP)

(73) Assignee: CASIO COMPUTER CO., LTD., Tokyo (JP)

(21) Appl. No.: 13/335,136

(22) Filed: Dec. 22, 2011

(30) Foreign Application Priority Data
Dec. 24, 2010 (JP) 2010-288851

(51) Int. Cl. G06F 3/041

(52) U.S. Cl. 345/173

(57) ABSTRACT

A display apparatus includes first and second coordinate detecting lines. Each second coordinate detecting line is arranged between a second and third of four pixel electrodes arranged in a first direction. Two signal lines are arranged between first and second pixel electrodes or between a third and fourth pixel electrodes. Pixel transistors are connected to the second and third pixel electrodes, facing each other across one second coordinate detecting line, and arranged far from the second coordinate detecting line. A first and a second coordinate detecting part are arranged between pixel transistors connected to the second and third pixel electrodes.

### CROSS-REFERENCE TO RELATED APPLICATIONS

This application is based upon and claims the benefit of priority from prior Japanese Patent Application No. 2010-288851, filed Dec. 24, 2010, the entire contents of which are incorporated herein by reference.

### BACKGROUND OF THE INVENTION

1. Field of the Invention

This invention relates to a display apparatus that has a touch panel function.

2. Description of the Related Art

Some types of displays incorporate a touch panel function. Any display of these types has a first substrate (TFT substrate) and a second substrate (color filter substrate) that are opposed to each other. On the TFT substrate, a plurality of pixel electrodes is formed at regular intervals, in a first direction (X direction) and a second direction (Y direction). The pixel electrodes are shaped like a rectangle. On the color filter substrate, a counter electrode is formed. In the gap between the plurality of pixel electrodes, on the one hand, and the counter electrode, on the other, liquid crystal is sealed, forming a liquid crystal layer.

FIG. 15 is a planar view of the display. The pixel electrodes 1 are arranged at regular intervals in the X direction and the Y direction. To each pixel electrode, a thin film transistor 2 (hereinafter referred to as TFT) used as a pixel transistor is connected to an end of each pixel electrode 1. Data lines 3 are arranged, each extending between two pixel electrodes 1 adjacent to each other in the X direction. X-coordinate detecting lines 4 are arranged, each extending between two of every three pixel electrodes 1 adjacent to one another in the X direction. One data line 3, another data line 3, one X-coordinate detecting line 4, and still another data line 3 are arranged in the order they are mentioned, from the left to the right in the X direction, between the pixel electrodes 1 spaced part in the X direction. This arrangement of lines is repeated the TFT substrate.

Between any two pixel electrodes 1 adjacent in the Y direction, a TFT 2, a gate line 5 used as a scanning line, a Y-coordinate detecting line 7, and an auxiliary capacitance line 6 are arranged. The TFT 2 has its gate electrode connected to a gate line 5, its drain electrode connected to a data line 3, and its source electrode connected to a pixel electrode 1.

Base parts 8 are provided. Each base part 8 is positioned between two pixel electrodes 1 adjacent in the Y direction and between one data line 3 and one X-coordinate detecting line 4 provided on the right of the data line 3, and is mounted on one Y-coordinate detecting line 7. FIG. 16 is a planar view, showing one base part 8 and some components arranged around the base part 8.

An X-coordinate detecting contact part 9 and a Y-coordinate detecting contact part 10, which are paired, are provided between two pixel electrodes 1 adjacent in the Y direction and between one data line 3 and one X-coordinate detecting line 4 provided on the right of the data line 3, and are mounted on one Y-coordinate detecting line 7. FIG. 17 is a planar view, showing one X-coordinate detecting contact part 9 and one Y-coordinate detecting contact part 10, and some components arranged around the contact parts 9 and 10.

Of the detecting contact parts 9 and 10 paired with each other, the X-coordinate detecting contact part 9 has two contacts provided on the TFT substrate and the color filter substrate, respectively. When the contacts of the X-coordinate detecting contact part 9 are electrically connected, an X-coordinate signal is generated. Similarly, the Y-coordinate detecting contact part 10 has two contacts provided on the TFT substrate and the color filter substrate, respectively. When the contacts of Y-coordinate detecting contact part 10 are electrically connected, a Y-coordinate signal is generated. Each base part 8 spaces the contacts of an X-coordinate detecting contact part 9 apart from each other by a prescribed distance, and the contacts of a Y-coordinate detecting contact part 10 from each other by a prescribed distance.

The touch panel technology is disclosed in, for example, Jpn. Pat. Appln. KOKAI Publication No. 2007-095044.

In the display described above, which has a touch panel function, an TFT 2, a gate line 5, a Y-coordinate detecting line 7 and an auxiliary capacitance line 6 are arranged between two pixel electrodes 1 adjacent in the Y direction, and a base part 8 or an X-coordinate detecting contact part 9 and a Y-coordinate detecting contact part 10, which are paired, are arranged between one data line 3 and the X-coordinate detecting line 4 provided on the right of this data line 3.

As a factor contributing to the performance of the display, for example an increase in the display luminance, the size of the pixel electrodes 1, i.e., aperture ratio, is exemplified. However, the size of the pixel electrodes 1, or the aperture ratio of the display, cannot be increased. This is because a TFT 2, a gate line 5, a Y-coordinate detecting line 7 and an auxiliary capacitance line 6 are arranged between two pixel electrodes 1 adjacent in the Y direction, and a base part 8 or an X-coordinate detecting contact part 9 and a Y-coordinate detecting contact part 10, which are paired, are arranged between one data line 3 and the X-coordinate detecting line 4 provided on the right of the data line 3.

### BRIEF SUMMARY OF THE INVENTION

One embodiment of the display apparatus according to this invention comprises: a plurality of pixel electrodes arranged in a first direction and a second direction different from the first direction; a counter electrode arranged, facing to the plurality of pixel electrodes; a plurality of pixel transistors connected to the plurality of the pixel electrodes, respectively; a plurality of first coordinate detecting lines arranged in the first direction; a plurality of second coordinate detecting lines arranged in the second direction; a plurality of signal lines arranged in the second direction and configured to supply display signals to the plurality of pixel transistors; a plurality of first coordinate detecting parts, each having a first contact, connected to the plurality of first coordinate detecting lines, respectively, and each configured to electrically connect one first coordinate detecting line to the counter electrode when the first contact touches the counter electrode upon receiving an external pressure; and a plurality of second coordinate detecting parts, each having a second contact, connected to the plurality of second coordinate detecting lines, respectively, and each configured to electrically connect one second coordinate detecting line to the counter electrode when the second contact touches the counter electrode upon receiving the pressure. Each second coordinate detecting line is arranged between the second and third of every four pixel electrodes continuously arranged in the first direction. Two signal lines are arranged between the first and second pixel electrodes or between the third and fourth pixel electrodes. Each pixel transistor are connected to the second and third pixel electrodes, respectively, facing each other across one second coordinate detecting line, and arranged far from the second coordinate detecting line. The first coordinate detecting part and the second coordinate detecting part are arranged between Each pixel transistors connected to the second and third pixel electrodes, respectively.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a configuration diagram showing a first embodiment of a display according to this invention, which has a touch panel function;

FIG. 2 is a planar view showing a part of the display;

FIG. 3 a planar view showing one base part and the components arranged around the base part;

FIG. 4 is a sectional view taken along line A-A (IVB-IVB), showing one of the base parts used in the display;

FIG. 5 is a planar view showing an X-coordinate detecting contact part and a Y-coordinate detecting contact part, both used in the display, and the components arranged around the X- and Y-coordinate detecting parts;

FIG. 6 is a sectional view of a pair of X- and Y-coordinate detecting parts, taken along line B-B (IVC-IVC and IVD-IVD);

FIG. 7A is a sectional view taken along line IVA-IVA shown in FIG. 3, showing a part equivalent to a TFT and explaining the first step of manufacturing the display;

FIG. 7B is a sectional view taken along line IVB-IVB shown in FIG. 3, showing a part equivalent to a base part and explaining the first step of manufacturing the display;

FIG. 7C is a sectional view taken along line IVC-IVC shown in FIG. 5, showing a part equivalent to an X-coordinate detecting part and explaining the first step of manufacturing the display;

FIG. 7D is a sectional view taken along line IVD-IVD shown in FIG. 5, showing a part equivalent to a Y-coordinate detecting part and explaining the first step of manufacturing the display;

FIG. 8A is a sectional view taken along line IVA-IVA shown in FIG. 3, showing a part equivalent to an TFT and explaining the next step of manufacturing the display;

FIG. 8B is a sectional view taken along line IVB-IVB shown in FIG. 3, showing a part equivalent to a base part and explaining the next step of manufacturing the display;

FIG. 8C is a sectional view taken along line IVC-IVC shown in FIG. 5, showing a part equivalent to an X-coordinate detecting part and explaining the next step of manufacturing the display;

FIG. 8D is a sectional view taken along line IVD-IVD shown in FIG. 5, showing a part equivalent to a Y-coordinate detecting part and explaining the next step of manufacturing the display;

FIG. 9A is a sectional view taken along line IVA-IVA shown in FIG. 3, showing a part equivalent to a TFT and explaining the next step of manufacturing the display;

FIG. 9B is a sectional view taken along line IVB-IVB shown in FIG. 3, showing a part equivalent to a base part and explaining the next step of manufacturing the display;

FIG. 9C is a sectional view taken along line IVC-IVC shown in FIG. 5, showing a part equivalent to an X-coordinate detecting part and explaining the next step of manufacturing the display;

FIG. 9D is a sectional view taken along line IVD-IVD shown in FIG. 5, showing a part equivalent to a Y-coordinate detecting part and explaining the next step of manufacturing the display;

FIG. 10A is a sectional view taken along line IVA-IVA shown in FIG. 3, showing a part equivalent to a TFT and explaining the next step of manufacturing the display;

FIG. 10B is a sectional view taken along line IVB-IVB shown in FIG. 3, showing a part equivalent to a base part and explaining the next step of manufacturing the display;

FIG. 10C is a sectional view taken along line IVC-IVC shown in FIG. 5, showing a part equivalent to an X-coordinate detecting part and explaining the next step of manufacturing the display;

FIG. 10D is a sectional view taken along line IVD-IVD shown in FIG. 5, showing a part equivalent to a Y-coordinate detecting part and explaining the next step of manufacturing the display;

FIG. 11A is a sectional view taken along line IVA-IVA shown in FIG. 3, showing a part equivalent to a TFT and explaining the next step of manufacturing the display;

FIG. 11B is a sectional view taken along line IVB-IVB shown in FIG. 3, showing a part equivalent to a base part and explaining the next step of manufacturing the display;

FIG. 11C is a sectional view taken along line IVC-IVC shown in FIG. 5, showing a part equivalent to an X-coordinate detecting part and explaining the next step of manufacturing the display;

FIG. 11D is a sectional view taken along line IVD-IVD shown in FIG. 5, showing a part equivalent to a Y-coordinate detecting part and explaining the next step of manufacturing the display;

FIG. 12 is a diagram showing the display and a conventional display, compared with each other;

FIG. 13 is a configuration diagram showing a second embodiment of the display according to this invention, which also has a touch panel function;

FIG. 14 is a configuration diagram showing a third embodiment of the display according to this invention, which also has a touch panel function;

FIG. 15 is a planar view of a conventional display;

FIG. 16 is a planar view of the conventional display, showing one base part and some components around the base part; and

FIG. 17 is a planar view, showing one X-coordinate detecting contact part and one Y-coordinate detecting part, and some components arranged around these detecting parts.

### DETAILED DESCRIPTION OF THE INVENTION

### First Embodiment

A first embodiment of this invention will be described, with reference to the accompanying drawings. The components identical to those shown in FIG. 15 are designated by the same reference numbers in each drawing, and will not be described in detail.

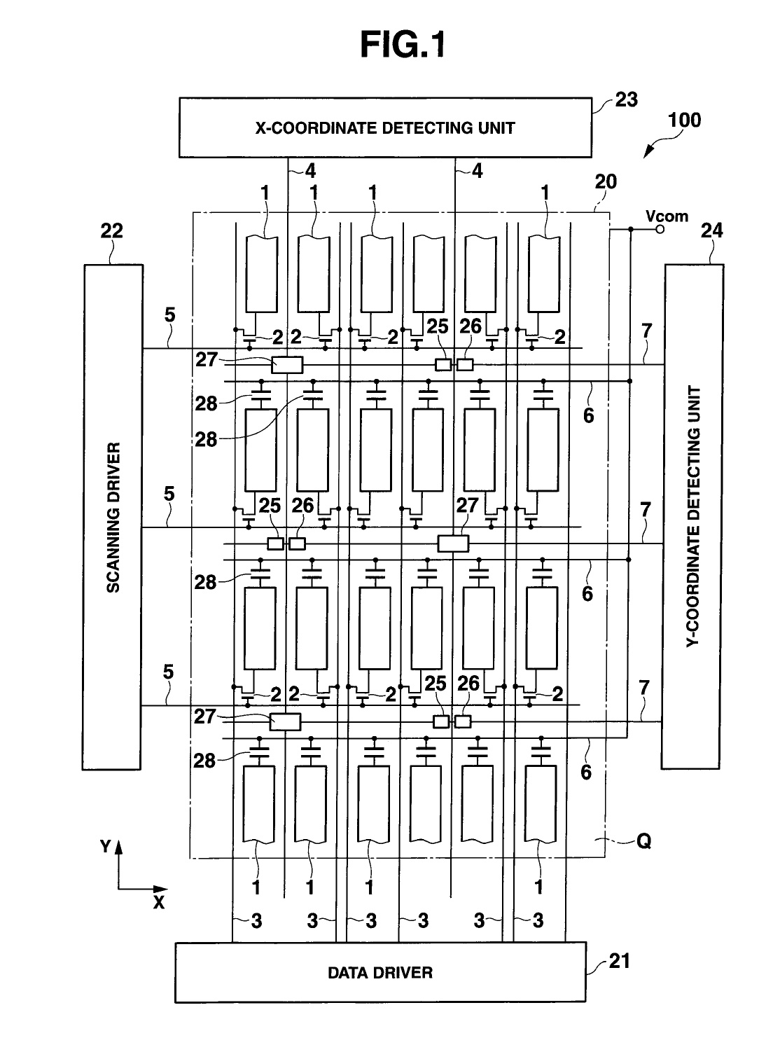

FIG. 1 shows a first embodiment of a display 100 according to this invention, which has a touch panel function. The display 100 has a first substrate (TFT substrate) and a second substrate (color filter substrate). On the TFT substrate, a plurality of pixel electrodes 1 is provided. The pixel electrodes 1 are shaped like a rectangle. The pixel electrodes 1 are arranged, at regular intervals, in X direction (or horizontal direction), forming rows each of which is composed of a specific number of electrodes, and in Y direction (or vertical direction), forming columns each of which is composed of a specific number of electrodes. The pixel electrodes 1 arranged in the X direction, at the uppermost position in FIG. 1, will be referred to as “first row,” the pixel electrodes 1 arranged in the X direction, at the second uppermost position in FIG. 1 will be referred to as “second row.” The pixel electrodes 1 arranged in the X direction, at the third uppermost position in FIG. 1 will be referred to as “third row,” the pixel electrodes 1 arranged in the X direction, at the fourth uppermost position in FIG. 1 will be referred to as “fourth row,” and so forth.

In FIG. 1, the leftmost column of pixel electrodes 1 arranged in the Y direction will be referred to as “first column,” and the column of pixel electrode 1, positioned on the right of the first column, will hereinafter referred to as “second column.” The other columns of pixel electrodes 1, positioned on further right will be referred as “third column,” “fourth column,” and so forth.

On the second substrate, a color filter layer is provided. On the color filter layer, a counter electrode 20 is arranged and opposed to the pixel electrodes 1 across the color filter layer. In the gap between the pixel electrodes, on the one hand, and the counter electrode 20, on the other, liquid crystal is sealed, forming a liquid crystal layer Q. The counter electrode 20 is located above the pixel electrodes 1.

In the gap between the pixel electrodes 1, on the one hand, and the counter electrode 20, on the other, electrophoretic particles electrically charged can be sealed, instead of the liquid crystal.

As shown in FIG. 1, thin film transistors (TFT) 2 used as pixel transistors are connected to the pixel electrodes 1, respectively. Each TFT 2 has its gate electrode connected to a gate line 5, its drain electrode connected to a data line 3, and its source electrode connected to a pixel electrode 1. The source electrode of each TFT 2 is connected to the left or right end (as viewed in the X direction) of the lower edge (as viewed in the Y direction) of the pixel electrode 1.

More specifically, between any two pixel electrodes 1 adjacent in the X direction, one or two data lines 3 are arranged. The source electrode of each TFT 2 is connected to the left or right end of the lower edge of one pixel electrode 1, at which a data line 3 extends. Since the TFT 2 is connected to the lower edge of the pixel electrode 1, at which the data line 3 is extends, it is arranged at the left or right end of the lower edge of the pixel electrode 1.

For example, the source electrode of a TFT 2 is connected to the left end of the lower edge of the leftmost pixel electrode 1 of the first column shown in FIG. 1. Thus, this TFT 2 is arranged at the left end of the lower edge of the pixel electrode 1. In the first row of pixel electrodes, the source electrode of the TFT 2 is connected to the right end of the lower edge of the pixel electrode 1 adjacent on the right of the pixel electrode 1. The TFT 2 is arranged at the right end of the lower edge of the pixel electrode 1. As for the pixel electrode 1 adjacent on the right, the source electrode of the TFT 2 is connected to the left end of the lower edge of the pixel electrode 1.

As for the pixel electrode 1 adjacent on the further right, the source electrode of a TFT 2 is connected to the left end of the lower edge of a pixel electrode 1. The TFT 2 is arranged at the left end of the lower edge of the pixel electrode 1. As for the pixel electrode 1 adjacent on the still further right, the source electrode of a TFT 2 is connected to the right end of the lower edge of the pixel electrode 1. This TFT 2 is arranged at the right end of the lower edge of the pixel electrode 1. As for the next pixel electrode 1 adjacent on the further right, the source electrode of a TFT 2 is connected to the left end of the lower edge of a pixel electrode 1. This TFT 2 is arranged at the left end of the lower edge of the pixel electrode 1. As for any other pixel electrode adjacent on the right, a TFT 2 is connected and arrange in a similar manner.

In a gap between any two rows of pixel electrodes 1, which are adjacent in the Y direction, an X-coordinate detecting part 25, a Y-coordinate detecting part 26, and a base part 27a are arranged, spaced from one another. The X-coordinate detecting part 25 and the Y-coordinate detecting part 26 are paired, forming a pair. The X- and Y-coordinate detecting parts 25 and 26 of any pair are arranged between two adjacent columns of pixel electrodes 1, on the sides of an X-coordinate detecting line 4, respectively. Any base part 27 is arranged between two adjacent columns of pixel electrodes 1, on sides of an X-coordinate detecting line 4, respectively. The paired X- and Y-coordinate detecting parts 25 and 26 are arranged adjacent to each other.

As shown in FIG. 1, one base part 27 is positioned between the first and second rows of pixel electrodes 1 and between the first and second columns of pixel electrodes 1, which are positioned on the sides of an X-coordinate detecting line 4. This base part 27 is positioned at the upper-left corner in FIG. 1.

An X-coordinate detecting part 25 and a Y-coordinate detecting part 26, which are paired, are arranged between the second and third row of pixel electrodes 1, and between the first and second columns of pixel electrodes 1, which extend along one X-coordinate detecting line 4.

A base part 27 is arranged between the third and fourth row of pixel electrodes 1, and between the first and second columns of pixel electrodes 1, which extend along one X-coordinate detecting line 4.

The other base parts 27 and the other pairs of X- and Y-coordinate detecting parts 25 and 26 are alternately arranged on any other X-coordinate detecting line 4 extending between two rows of pixel electrodes 1.

Between the first and second rows of pixel electrodes 1 and between the fourth and fifth columns of pixel electrodes 1, an X-coordinate detecting parts 25 and a Y-coordinate detecting part 26, which are paired, are arranged.

Between the second and third rows of pixel electrodes 1 and between the fourth and fifth columns of pixel electrodes 1, a base part 27 is arranged.

Between the third and fourth rows of pixel electrodes 1 and between the fourth and fifth columns of pixel electrodes 1, an X-coordinate detecting part 25 and a Y-coordinate detecting part 26, which are paired, are arranged.

Also between any other two adjacent rows of pixel electrodes 1 and between any other two adjacent columns of pixel electrodes 1, a base part 27 and a pair of X- and Y-coordinate detecting parts 25 and 26 are alternately arranged.

The display 100 comprises a data driver (data drive circuit) 21, a scanning deriver (scanning drive circuit) 22, an X-coordinate detecting unit 23, and a Y-coordinate detecting unit 24.

The data lines 3 are connected, at one end, to the data driver 21. The data driver 21 supplies a video signal to the data lines 3. The data lines 3 are connected, at the other end, to the drain electrodes of the TFTs 2.

To the scanning deriver 22, the gate lines 5 are connected, at one end. The scanning deriver 22 supplies scanning signals to the gate lines 5, at prescribed scanning timing, to perform scanning. The scanning signals turn on the TFTs 2, one after another. The gate lines 5 are connected, at the other end, to the gate electrodes of the TFTs 2.

The scanning deriver 22 outputs a scanning signal and the data driver 21 outputs a video signal, at specific timing described below. The scanning deriver 22 outputs a scanning signal to the gate lines 5, one after another. While the scanning signal is being output to one gate line 5, the data driver 21 outputs the video signal to all data lines 3 at the same time. The scanning signal is thereby supplied to the gate electrode of the TFT 2 through the gate line 5, and the video signal is supplied to the drain of the TFT 2 through the data line 3. In the TFT 2 which has received the scanning signal at the gate electrode and video signal at the drain electrode, the drain electrode and source electrode are electrically connected. As a result, the voltage corresponding to the video signal is applied to the pixel electrode 1 connected to the source electrode of the TFT 2. A voltage difference is generated between the pixel electrode 1 and the counter electrode 20. That part of the liquid crystal layer Q, which contacts the pixel electrode 1 is therefore driven.

The X-coordinate detecting unit 23 is connected to the X-coordinate detecting line 4. On each X-coordinate detecting line 4, the X-coordinate detecting parts 25 are provided. The X-coordinate detecting parts 25 have a contact each. When any X-coordinate detecting part 25 is externally pressed, its contact touches the counter electrode 20, electrically connecting the counter electrode 20 to the X-coordinate detecting line 4. Therefore, the detecting unit 23 receives, via the X-coordinate detecting line 4, the X-coordinate signal generated when the user touches the display 100, pressing the X-coordinate detecting part 25 and ultimately connecting the X-coordinate detecting part 25 to the counter electrode 20. Thus, the X-coordinate detecting unit 23 detects the X coordinate of the part the user has touched.

The Y-coordinate detecting unit 24 is connected to a plurality of Y-coordinate detecting lines 7. On each Y-coordinate detecting line 7, the Y-coordinate detecting parts 26 are provided. Each Y-coordinate detecting part 26 has a contact. When the contact is externally pressed, touching the counter electrode 20, the counter electrode 20 is electrically connected to the Y-coordinate detecting lines 7. The Y-coordinate detecting unit 24 receives, via the Y-coordinate detecting line 7, the Y-coordinate signal generated when the user touches the display 100, pressing the Y-coordinate detecting part 26 and ultimately connecting the Y-coordinate detecting part 26 to the counter electrode 20. The Y-coordinate detecting unit 24 therefore detects the Y coordinate of the part the user has touched.

While no pressure is being applied, the base parts 27 space the contacts of the X-coordinate detecting parts 25 from the counter electrode 20 by a prescribed distance, and space the contacts of the Y-coordinate detecting parts 26 from the counter electrode 20 by a prescribed distance. The base parts 27 are provided on the Y-coordinate detecting lines 7.

Between any two rows of pixel electrodes 1, the rows spaced apart in the Y direction, one auxiliary capacitance line 6 is arranged. The auxiliary capacitance line 6 and the pixel electrodes 1 form auxiliary capacitances 28. The auxiliary capacitance line 6 connects these auxiliary capacitances 28, one to another.

In the configuration described above, one data line 3, one X-coordinate detecting line 4 and two data lines 3 are repeatedly arranged in the order mentioned, from the left to the right (FIG. 1), between the rows of pixel electrodes 1, the rows extending in the horizontal direction. The order in which one X-coordinate detecting line 4 and two data lines 3 are repeatedly arranged is not limited to the order starting with one data line 3. Instead, the X-coordinate detecting line 4 or the two data lines 3 may be arranged leftmost. If the X-coordinate detecting line 4 is arranged leftmost, the X-coordinate detecting line 4, the two data lines 3 and the data line 3 will be repeatedly arranged in the order they are mentioned.

Since one data line 3, one X-coordinate detecting line 4 and two data lines 3 are repeatedly arranged in the order they are mentioned, each TFT 2 is positioned on the left or write of one pixel electrode 1 in the X direction, depending on the positions at which the data line 3 and the two data lines 3 are arranged. As shown in FIG. 1, the first TFT 2 is arranged, for example, at the left end of the lower edge of the leftmost pixel electrode 1. The second TFT 2 on the right of the first TFT 2 is arranged at the right end of the lower edge of the second leftmost pixel electrode 1. The third TFT 2 on the right of the second TFT 2 is arranged at the left end of the lower edge of the third leftmost pixel electrode 1.

Similarly, the fourth TFT 2 on the right of the third TFT 2 is arranged at the left end of the lower edge of the fourth leftmost pixel electrode 1, the fifth TFT 2 on the right of the fourth TFT 2 is arranged at the right end of the lower edge of the fifth leftmost pixel electrode 1, the sixth TFT 2 on the right of the fifth TFT 2 is arranged at the left end of the lower edge of the sixth leftmost pixel electrode 1, and so forth.

The TFTs 2 so arranged are more spaced apart in the horizontal direction, than the TFTs 2 in the conventional display shown in FIG. 15. This is because some TFTs 2 are arranged at the left ends of the pixel electrodes 1 located on the right of an X-coordinate detecting line 4 and the remaining TFTs 2 are arranged at the right ends of the pixel electrodes 1 located on the left of the X-coordinate detecting line 4.

Base parts 27 and pairs of X- and Y-coordinate detecting parts 25 and 26 are arranged on each X-coordinate detecting line 4. Each base part 27 is located with its center aligned with the X-coordinate detecting line 4. The X- and Y-coordinate detecting parts 25 and 26 of each pair arranged side by side in the horizontal direction, with a gap between them. The X-coordinate detecting line 4 extends through the gap between the X- and Y-coordinate detecting parts 25 and 26.

Any two TFTs 2 arrange on the left and right of one X-coordinate detecting line 4 are spaced in the horizontal direction, more than the length of the base parts 27 or the length of the pairs of X- and Y-coordinate detecting parts 25 and 26, either measured in the horizontal direction. Hence, the base parts 27 and the pairs of X- and Y-coordinate detecting parts 25 and 26 are not aligned with the TFTs 2 in the vertical direction, and can arranged between any two TFTs 2 arranged in the horizontal direction. As a result of this, the gap between any two pixel electrodes 1 adjacent in the vertical direction can be narrower than in the conventional display.

Note that in the display 100, the area right of the rightmost pixel electrode 1 provided and the area left of the leftmost pixel electrode 1 are included in the region of pixel electrodes 1.

The X-coordinate detecting part 25 and Y-coordinate detecting part 26 of any pair are arranged in the horizontal direction, with one X-coordinate detecting line 4 located between them. Pairs of X- and Y-coordinate detecting parts 25 and 26 are arranged at positions where the counter electrode 20 is most bent when the user touches the display 100. That is, the pairs of X- and Y-coordinate detecting parts 25 and 26 are arranged at the intersections of the X-coordinate detecting lines 4 and Y-coordinate detecting lines 7, each for every six pixel electrodes 1 arranged in the horizontal direction.

Each base part 27 is arranged at the intersection of the X-coordinate detecting line 4 and Y-coordinate detecting line 7, other than those on which the pairs of X- and Y-coordinate detecting parts 25 and 26 are arranged, and is provided for every six pixel electrodes 1 arranged in the horizontal direction.

Any pair of X- and Y-coordinate detecting parts 25 and 26 is positioned at the midpoint between two adjacent base parts 27. At the midpoint, the counter electrode 20 may be bent most greatly when the user touches the display 100. Assume that a fourth base part 27 is provided, in addition to the three base parts 27 shown in FIG. Then, a square is formed, the corners of which are the four base parts 27. In fact, the display 100 has base parts 27 other than those shown in FIG. 1. Pairs of X- and Y-coordinate detecting parts 25 and 26 are arranged in the center part of the square the corners of which are four base parts 27.

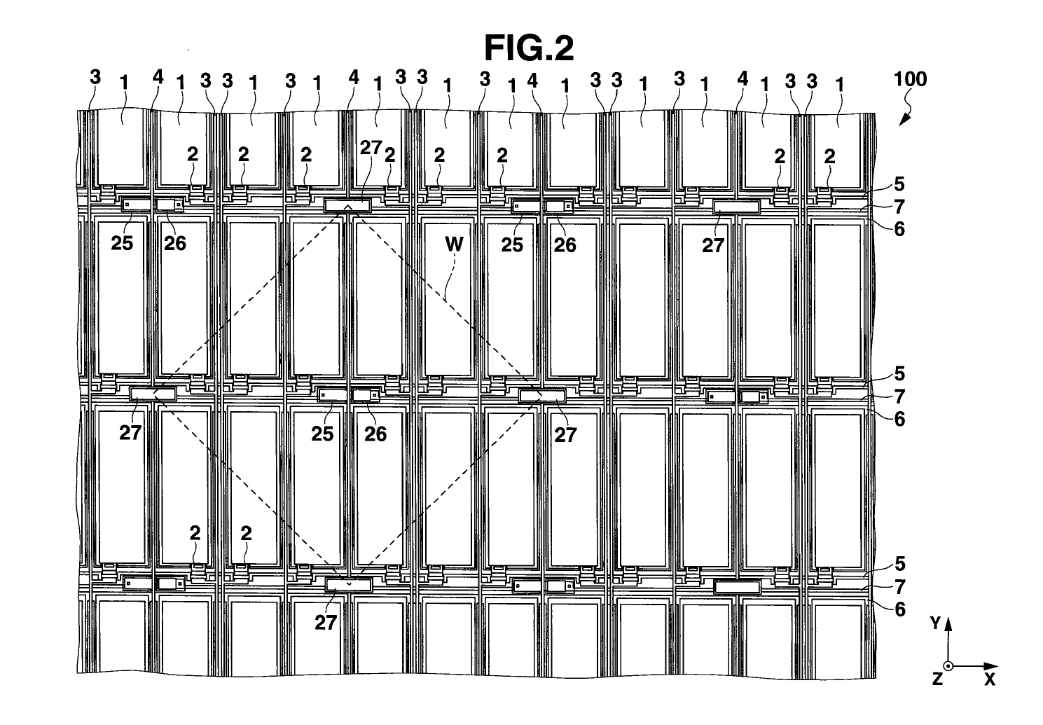

FIG. 2 is a planar view showing a part of the display 100. As described above, one data line 3, one X-coordinate detecting line 4 and two data lines 3 are repeatedly arranged in the order mentioned, from the left to the right, between the columns of pixel electrodes 1. Because of this arrangement, each TFT 2 is arranged on the left or right of a pixel electrode 1. More precisely, a TFT 2 is arrange at the left end of the lower edge of the leftmost pixel electrode 1 of the first row, pixel electrode 1, a TFT 2 is arranged at the right end of the lower edge of the second leftmost pixel electrode 1 provided, a TFT 2 is arranged at the left end of the lower edge of the third leftmost pixel electrode 1, and so forth, in the same way as shown in FIG. 1.

Hence, of two TFT 2 provided for any two adjacent pixel electrodes 1 arranged on the left and right of an X-coordinate detecting line 4, respectively, one TFT 2 is arranged at the left end of the lower edge of the pixel electrode 1 existing on the left of the X-coordinate detecting line 4, and the other TFT 2 is arranged at the right end of the lower edge of the pixel electrode 1 existing on the right of the X-coordinate detecting line 4. As a result, the TFTs 2 arranged on the left and right of the X-coordinate detecting line 4, respectively, are more spaced apart in the horizontal direction, than the TFTs 2 in the conventional display shown in FIG. 15.

The base parts 27 and the pairs of X- and Y-coordinate detecting parts 25 and 26 are the X-coordinate detecting line 4. The base parts 27 are arranged in the horizontal direction so that the X-coordinate detecting lines 4 may pass the centers of the base parts 27, respectively. The X- and Y-coordinate detecting parts 25 and 26 of any pair are arranged side by side in the horizontal direction. An X-coordinate detecting line 4 extends through the gap between the X- and Y-coordinate detecting parts 25 and 26.

Any two TFTs 2 arranged on the left and right of an X-coordinate detecting line 4 are spaced by a distance longer than the length of the base parts 27, as measured in the horizontal direction or the length of the any pair of X- and Y-coordinate detecting parts 25 and 26 arranged side by side. Therefore, the base parts 27 and the pairs of X- and Y-coordinate detecting parts 25 and 26 are not aligned with any TFT 2 in the vertical direction, and can be arranged between TFTs 2 arranged in the horizontal direction. Since the base parts 27 and the pairs of X- and Y-coordinate detecting parts 25 and 26 are arranged between the TFTs 2 arranged in the horizontal direction, the pixel electrodes 1 are less spaced apart in the vertical direction than in the conventional display shown in FIG. 15.

The X- and Y-coordinate detecting parts 25 and 26 of each pair are arranged in the horizontal direction, with an X-coordinate detecting line 4 extending between them. The X- and Y-coordinate detecting parts 25 and 26 of any pair are so positioned that the counter electrode 20 is most greatly bent when the user touches the display 100. More precisely, the X- and Y-coordinate detecting parts 25 and 26 are arranged at the intersection of an X-coordinate detecting line 4 and a Y-coordinate detecting line 7, and are provided for six pixel electrodes 1 arranged in the horizontal direction.

Each base part 27 is arranged at the intersection of the X-coordinate detecting line 4 and Y-coordinate detecting line 7, other than those on which the pairs of X- and Y-coordinate detecting parts 25 and 26 are arranged, and is provided for every six pixel electrodes 1 arranged in the horizontal direction.

Any pair of X- and Y-coordinate detecting parts 25 and 26 and any base part 27 are staggered in the horizontal direction by three pixel electrodes, at every other column of pixel electrodes 1. Therefore, the pairs of X- and Y-coordinate detecting parts 25 and 26 and the base parts 27 are alternately arranged along any X-coordinate detecting line 4 and in the vertical direction. Thus, also along the next X-coordinate detecting line 4 arranged on the right, pairs of X- and Y-coordinate detecting parts 25 and 26 and base parts are alternately arranged. That is, the pairs of X- and Y-coordinate detecting parts 25 and 26 and the base parts are alternately arranged in the horizontal direction, too, each pair for three pixel electrodes 1 and each base part for three pixel electrodes 1.

Because of this arrangement, any pair of X- and Y-coordinate detecting parts 25 and 26 is arranged at the midpoint between two adjacent base parts 27. At the midpoint, the counter electrode 20 can be bent most greatly when the user touches the display 100. For example, the pair of X- and Y-coordinate detecting parts 25 and 26 may be arranged, as shown in FIG. 2, at the center of a square W having the four corners at four base parts 27.

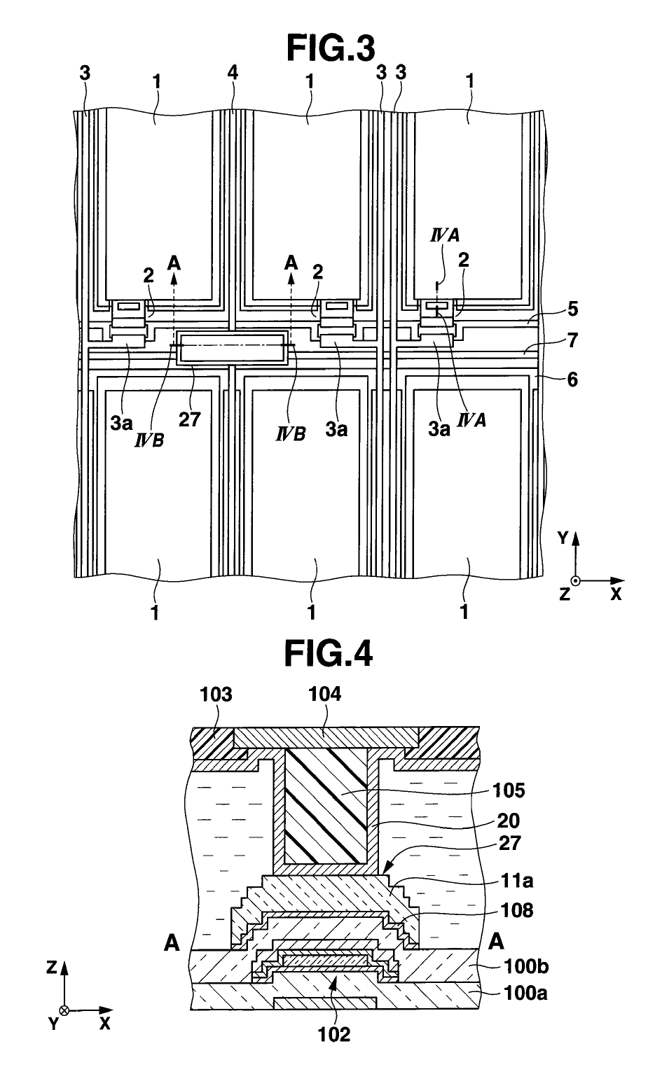

FIG. 3 a planar view showing one base part 27 and the components arranged around the base part 27. As shown in FIG. 3, one data line 3, one X-coordinate detecting line 4 and two data lines 3 are repeatedly arranged in the order mentioned, from the left to the right, spaced part in the horizontal direction. As described above, the data lines 3 extend in the Y direction, and intersect with the gate lines 5. From the intersections of the data lines 3 and gate lines 5, data lines 3a (branching data liens) extend in the same direction as the gate lines, namely in the X direction, and are connected to the drain electrodes of the TFTs 2.

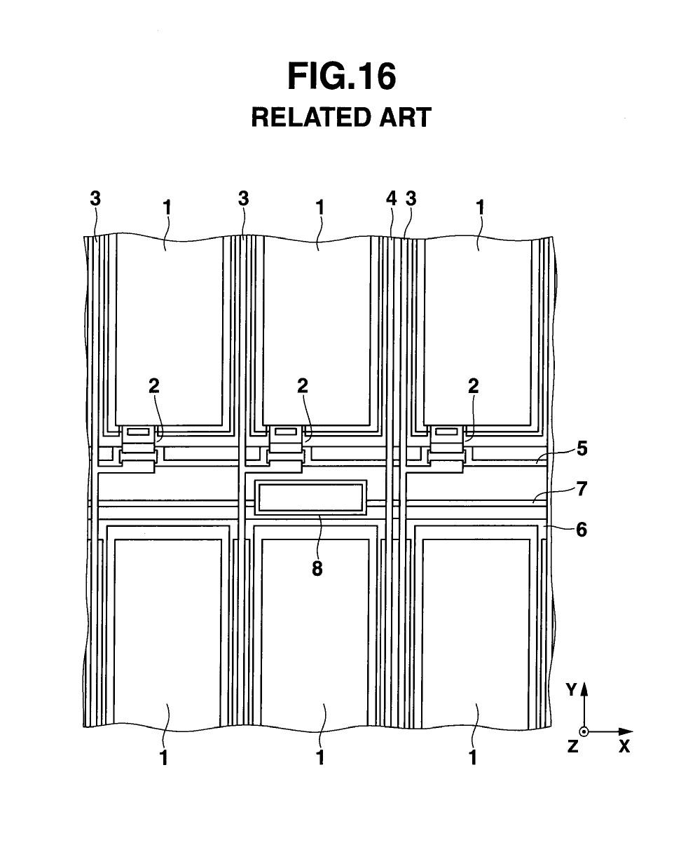

Each TFT 2 is arranged at the left or right end of the lower edge of one pixel electrode 1. In FIG. 3, an X-coordinate detecting line 4 extends though the gap between the leftmost pixel electrode 1 and the electrode 1 arranged on the right of the leftmost pixel electrode 1. At the left end of the lower edge of the leftmost pixel electrode 1, a TFT 2 is arranged. The TFT 2 on the right of this TFT 2 is arranged at the right end of the lower edge of the pixel electrode 1 positioned on the right of the leftmost pixel electrode 1. As a result, the two TFTs 2 arranged on the left and right of any X-coordinate detecting line 4, respectively, are more spaced in the horizontal direction, than the TFTs shown in FIG. 16.

The two TFTs 2 arranged on the left and right of the X-coordinate detecting line 4, respectively, are spaced by a distance longer than the length of each base part 27, as measured in the horizontal direction. Therefore, the base parts 27 are not aligned with any TFT 2 in the vertical direction, and can be arranged between TFTs 2 arranged in the horizontal direction. The pixel electrodes 1 can therefore be less spaced apart in the vertical direction than in the conventional display shown in FIG. 16.

FIG. 4 is a sectional view taken along line A-A shown in FIG. 3, showing one of the base parts 27 shown in FIG. 3. Each of the TFTs provided on the TFT substrate is several films, one laid on another, for example, a gate film, a gate insulating film 100a, an intrinsic silicon film, a channel protection film, an n⁺ silicon film, a source-drain film, and an overcoat insulting film 100b. The gate film is made of, for example, aluminum, chromium or molybdenum. The gate insulating film 100a is made of, for example, silicon nitride. The intrinsic silicon film is made of intrinsic amorphous silicon. The channel protection film is made of, for example, silicon nitride. The n⁺ silicon film is made of, for example, n⁺ amorphous silicon. The source-drain film is made of, for example, aluminum, chromium or molybdenum. The overcoat insulting film 100b is made of, for example, silicon nitride.

On the color filter substrate, a color filter 103, a black matrix 104, and a plurality of contact projections 105. The contact projections 105 are arranged, opposed to the X-coordinate detecting parts 25, Y-coordinate detecting parts 26, and base parts 27. The counter electrode 20 is provided on the contact projections 105, color filter 103 and black matrix 104.

Each base part 27 is mounted is mounted on the overcoat insulating film 100b. The base part 27 comprises an electrode 108 and a height adjusting member 11a. The electrode 108 is made of, for example, ITO, i.e., material of the pixel electrodes 1. The height adjusting member 11a is provided on the electrode 108 and made of, for example, silicon nitride. Each contact projection 105 serves as a columnar spacer and contracts the height adjusting member 11a. The contacts of the X- and Y-coordinate detecting parts 25 and 26 of any pair are thereby spaced apart by the same distance while the X- and Y-coordinate detecting parts 25 and 26 are receiving no external pressure.

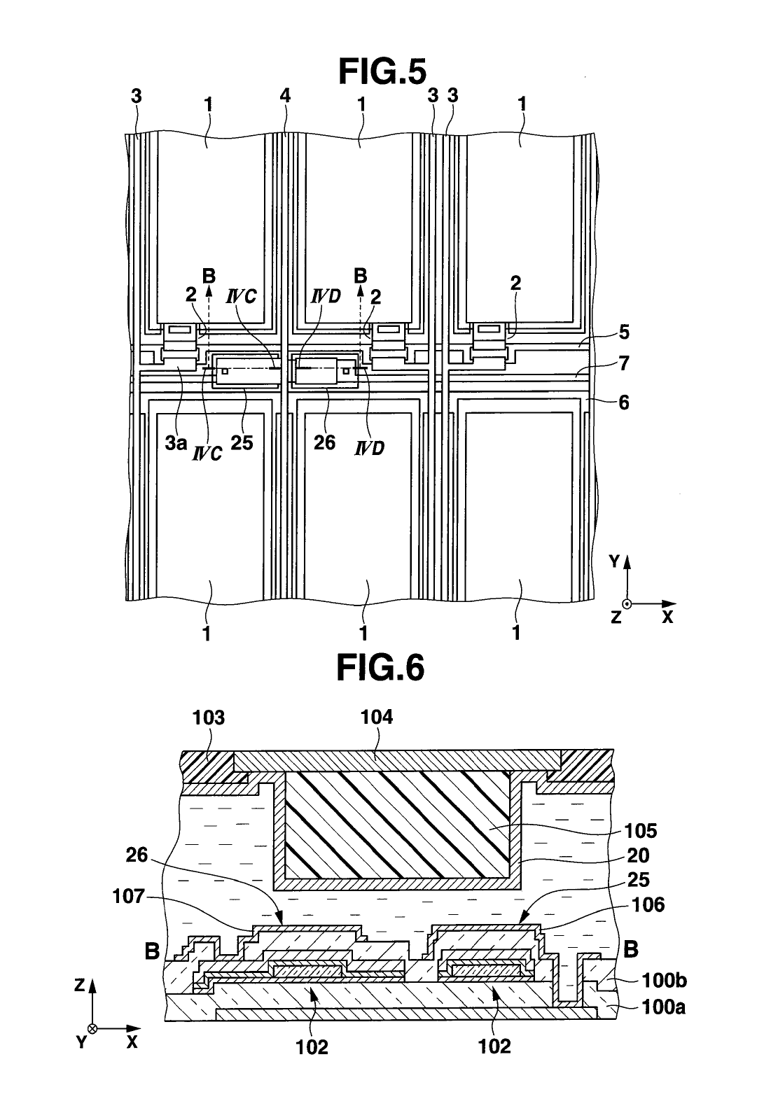

FIG. 5 is a planar view showing a pair of X- and Y-coordinate detecting parts 25 and 26, and the components arranged around the X- and Y-coordinate detecting parts 25 and 26. As described above, one data line 3, one X-coordinate detecting line 4 and two data lines 3 are repeatedly arranged in the order mentioned, from the left to the right, between the columns of pixel electrodes 1. A pair of X- and Y-coordinate detecting parts 25 and 26 is arranged at an intersection of an X-coordinate detecting line 4 and a Y-coordinate detecting line 7, for every two pixel electrodes 1 arranged in the Y direction.

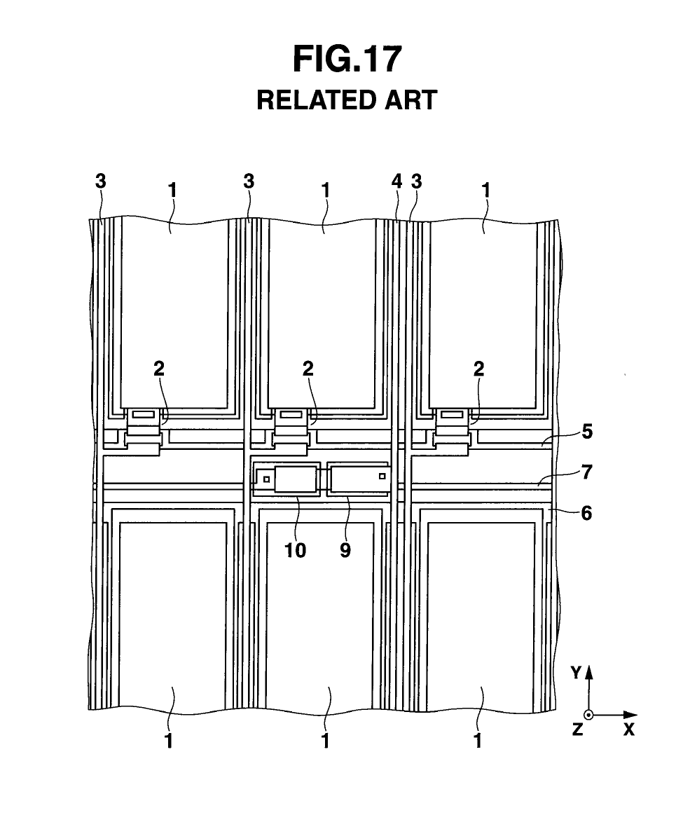

Each TFT 2 is arranged at the left or right end of the lower edge of one pixel electrode 1. In FIG. 5, an X-coordinate detecting line 4 extends though the gap between the leftmost pixel electrode 1 and the electrode 1 arranged on the right of the leftmost pixel electrode 1. At the left end of the lower edge of the leftmost pixel electrode 1, a TFT 2 is arranged. The TFT 2 on the right of this TFT 2 is arranged at the right end of the lower edge of the pixel electrode 1 positioned on the right of the leftmost pixel electrode 1. As a result, the two TFTs 2 arranged on the left and right of any X-coordinate detecting line 4, respectively, are more spaced in the horizontal direction, than the TFTs shown in FIG. 17.

The two TFTs 2 arranged on the left and right of the X-coordinate detecting line 4, respectively, are spaced by a distance longer than the length of the pair of X- and Y-coordinate detecting parts 25 and 26, as measured in the horizontal direction. Therefore, the pair of X- and Y-coordinate detecting parts 25 and 26 is not aligned with any TFT 2 in the vertical direction, and can be arranged between TFTs 2 arranged in the horizontal direction. The pixel electrodes 1 can therefore be less spaced apart in the vertical direction than in the conventional display shown in FIG. 17.

FIG. 6 is a sectional view of a pair of X- and Y-coordinate detecting parts 25 and 26, taken along line B-B shown in FIG. 5. (IVC-IVC and IVD-IVD). In FIG. 5, line B-B is a line composed of line IVC-IVC and line IVD-IVD. The X-coordinate detecting part 25 has an X-coordinate detecting contact 107 made of the same material as the pixel electrodes, e.g., ITO, and formed on the overcoat insulating film 100b. The X-coordinate detecting contact 107 is connected to the X-coordinate detecting line 4 provided in a layered structure 102. The X-coordinate detecting part 25 generates an X-coordinate signal if the X-coordinate detecting contact 107 receives an external pressure and is thereby electrically connected to the counter electrode 20.

Each Y-coordinate detecting part 26 has a Y-coordinate detecting contact 106 made of the same material as the pixel electrodes 1, e.g., ITO, and is formed on the overcoat insulating film 100b. The Y-coordinate detecting contact 106 is connected to the Y-coordinate detecting line 7 provided in the layered structure 102. The Y-coordinate detecting part 26 generates a Y-coordinate signal if the Y-coordinate detecting contact 106 receives an external pressure and is thereby electrically connected to the counter electrode 20.

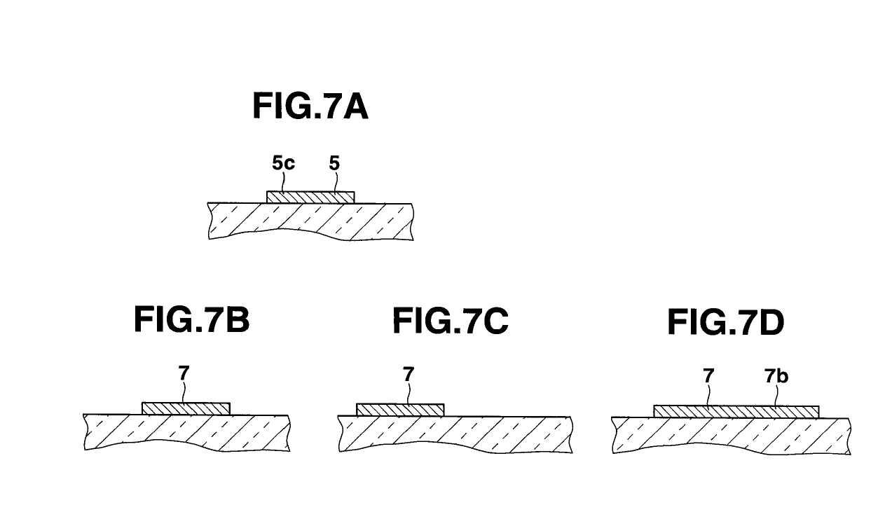

How each TFT 2, each base part 27, each X-coordinate detecting part 25, and each Y-coordinate detecting part 26 are formed, in the same way, on the first substrate (TFT substrate) will be described in detail, with reference to FIGS. 7A to 11D.

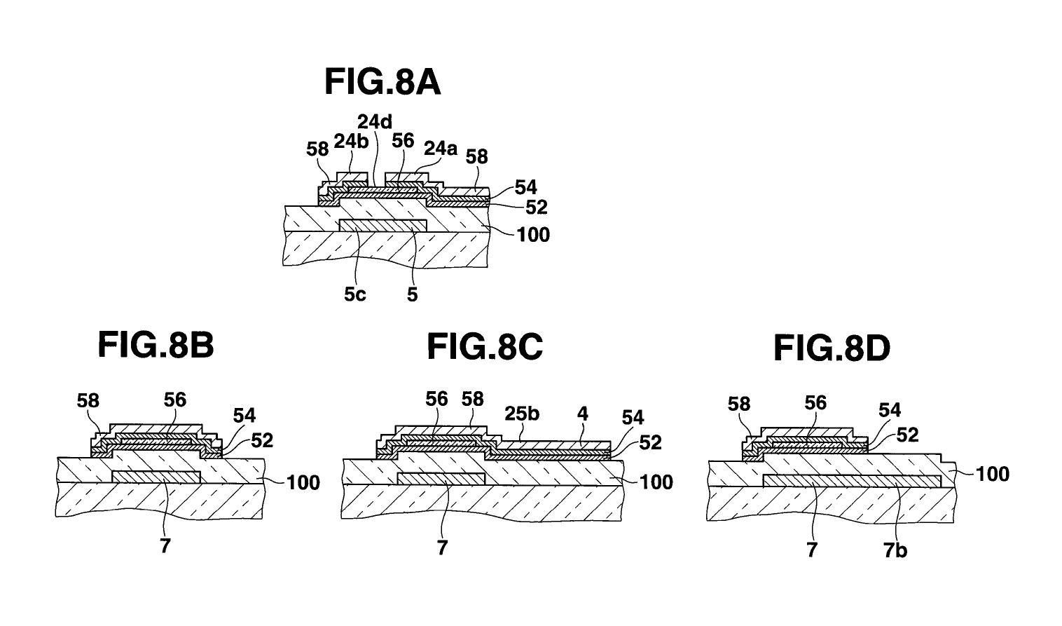

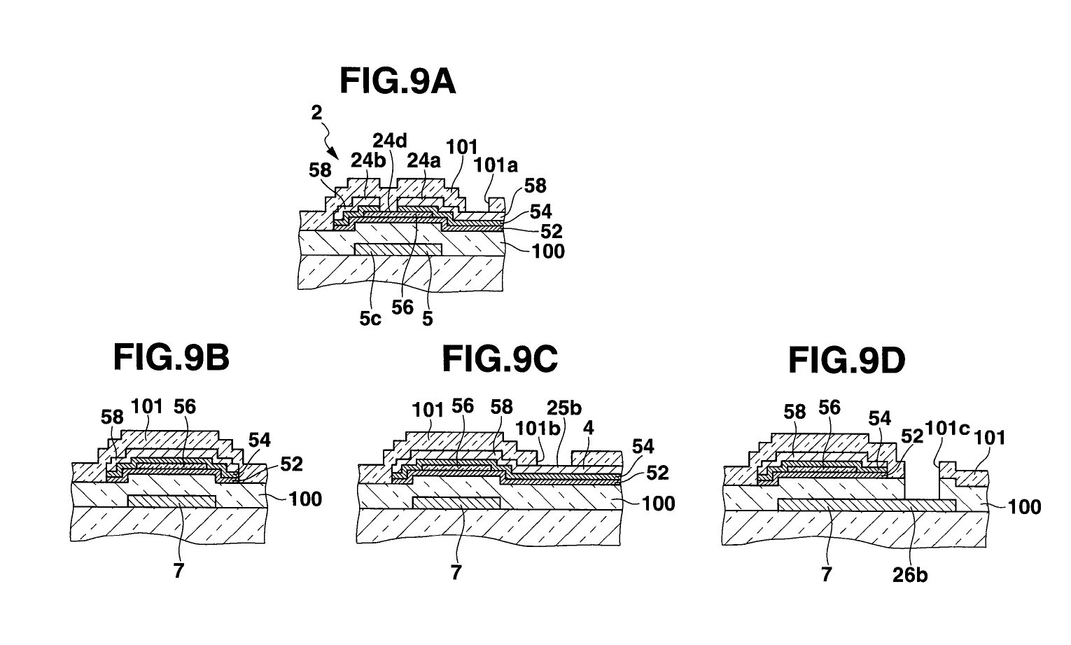

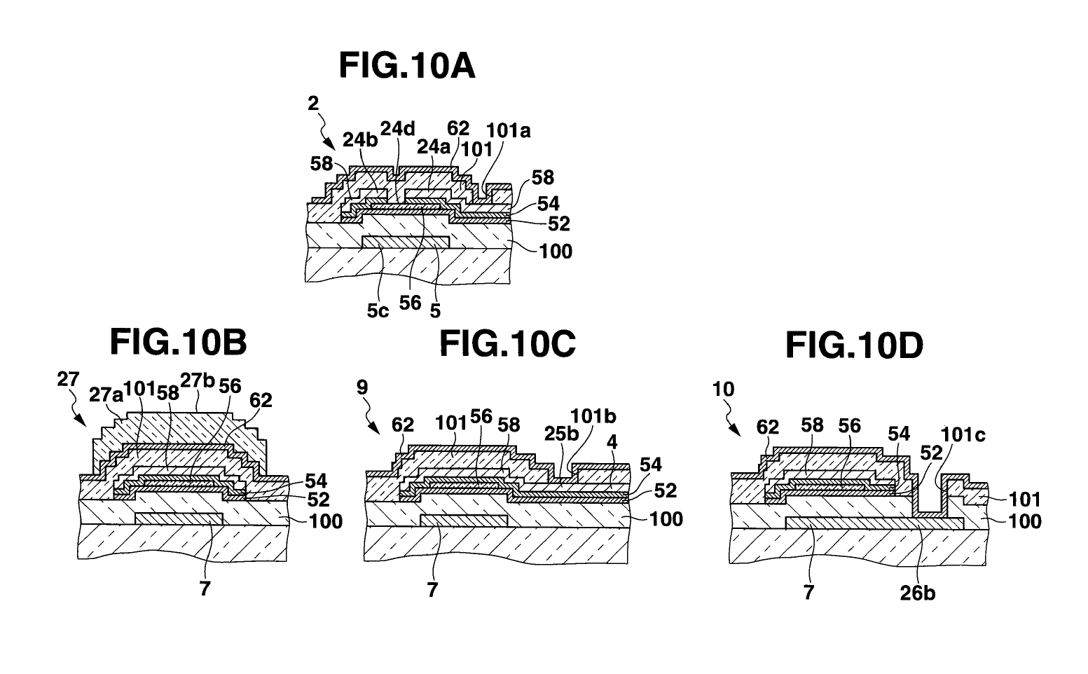

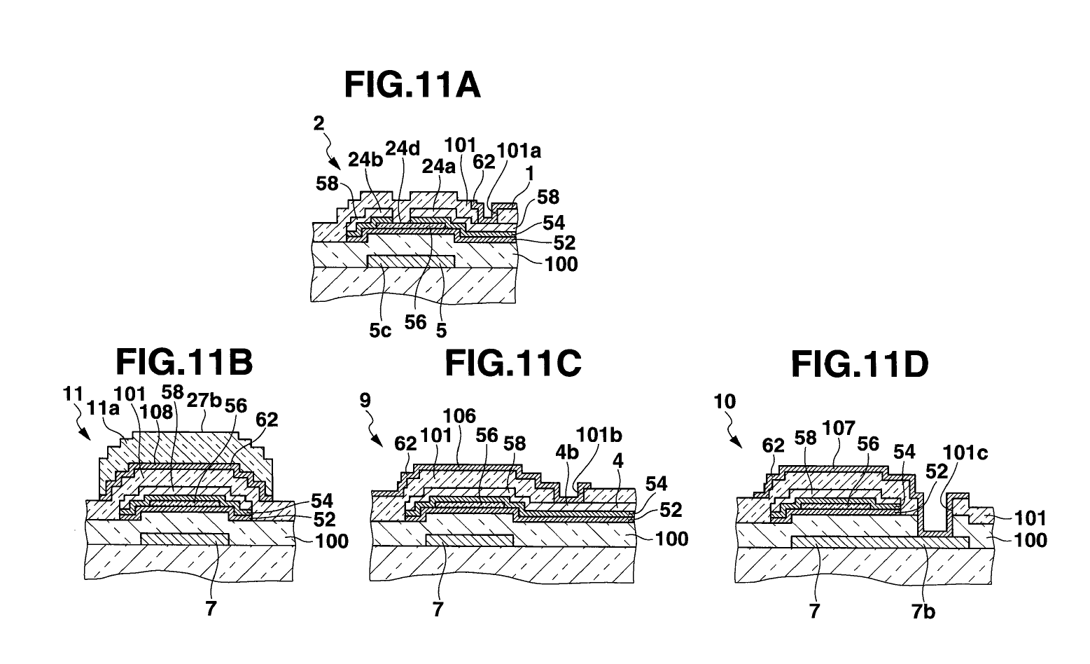

FIG. 7A, FIG. 8A, FIG. 9A, FIG. 10A and FIG. 11A are sectional views, showing how a TFT 2 is formed at position IVA-IVA shown in FIG. 3.

FIG. 7B, FIG. 8B, FIG. 9B, FIG. 10B and FIG. 11B are sectional views, showing how a base part 27 is formed at position IVB-IVB shown in FIG. 3, at the same time the TFT 2 is formed.

FIG. 7C, FIG. 8C, FIG. 9C, FIG. 10C and FIG. 11C are sectional views, showing how an X-coordinate detecting part 25 is formed at position IVC-IVC shown in FIG. 3, at the same time the TFT 2 is formed.

FIG. 7D, FIG. 8D, FIG. 9D, FIG. 10D and FIG. 11D are sectional views, showing how a Y-coordinate detecting part 26 is formed at position IVD-IVD shown in FIG. 3, at the same time the TFT 2 is formed.

First, as shown in FIGS. 7A to 7D, a Y-coordinate detecting line 7 is formed on that part of the first substrate (TFT substrate), which corresponds to the TFT 2, base part 27, X-coordinate detecting part 25 or Y-coordinate detecting part 26, by means of photolithography utilizing a gate film made of, for example, aluminum, chromium or molybdenum. The Y-coordinate detecting line 7, thus formed, extends along a gate line 5. That part of the gate line 5, which corresponds to the TFT 2, provides the gate electrode 5c of the TFT 2. That part of the Y-coordinate detecting line 7, which corresponds to the Y-coordinate detecting part 26, provides a connection part 7b for the Y-coordinate detecting part 26.

Next, as shown in FIGS. 8A to 8D, a transparent gate insulating film 100 is formed on those parts of the first substrate, which corresponds to the TFT 2, base part 27, X-coordinate detecting part 25 or Y-coordinate detecting part 26. The transparent gate insulating film 100 is made of, for example, silicon nitride (SiNx) and covers the gate line 5 and Y-coordinate detecting line 7.

Then, an a-Si layer 52 made of, for example, intrinsic amorphous silicon, and a n⁺ a-Si layer 54 made of, for example, n⁺ amorphous silicon, are formed, one on the other. A channel protection film 56 made of, for example, SiNx, is interposed between the selected parts of the a-Si layer 52 and n⁺ a-Si layer 54.

Thereafter, a source-drain film 58 made of, for example, aluminum, chromium or molybdenum is formed, covering the n⁺ a-Si layer 54. The source-drain film 58 provides a data line 3 and an X-coordinate detecting line 4, both positioned near the TFT 2. That part of the X-coordinate detecting line 4, which corresponds to the X-coordinate detecting part 25, provides a connection part 25b for the X-coordinate detecting part 25.

As shown in FIG. 8A, the n⁺ a-Si layer 54 and the source-drain film 58 are divided, each into two parts located close to and far from a pixel electrode 1, respectively.

The a-Si layer 52, the channel protection film 56, and the n⁺ a-Si layer 54 divided into two parts constitute an ohmics layer 24d. That part of the source-drain film 58, which is close to the pixel electrode 1, provides the source electrode 24a of the TFT 2. The other part of the source-drain film 58, which is far from the pixel electrode 1, provides the drain electrode 24b of the TFT 2.

Next, as shown in FIG. 9A to FIG. 9D, a transparent overcoat insulating film 101 made of, for example, silicon nitride (SiNx) is formed at parts that correspond to the TFT 2, base part 27, X-coordinate detecting part 25 and Y-coordinate detecting part 26. The overcoat insulating film 101 covers the source-drain film 58.

As shown in FIG. 9A, a contact hole 101a is made in that part of the overcoat insulating film 101, which corresponds to the TFT 2, more precisely in that part of the source-drain film 58, which corresponds to the source electrode 24a. The contact hole 101a therefore exposes the source electrode 24a of the TFT 2.

As shown in FIG. 9C, a contact hole 101b is made in that part of the overcoat insulating film 101, which corresponds to that part of the X-coordinate detecting line 4, which in turn corresponds to the connection part 25b for the X-coordinate detecting part 25. The contact hole 101b therefore exposes the connection part 25b.

As shown in FIG. 9D, a contact hole 101c is made in that part of the overcoat insulating film 101, which corresponds to that part of the Y-coordinate detecting line 7, which in turn corresponds to the connection part 26b for the Y-coordinate detecting part 26. The contact hole 101c therefore exposes the connection part 26b. The contact hole 101c penetrates the gate insulating film 100 provided between the overcoat insulating film 101 and the connection part 26b for the Y-coordinate detecting part 26.

At this stage of manufacture, the TFT 2 is provided at the TFT part shown in FIG. 9A. The TFT 2 comprises the gate electrode 5c formed by using the gate line 5, that part of the gate insulating film 100, which overlaps the gate electrode 5c, the a-Si layer 52 and the channel protection film 56 overlapping the gate electrode 5c, the ohmics layer 24d including the both parts of the n⁺ a-Si layer 54, the source electrode 24a and drain electrode 24b formed by dividing the ohmics layer 24d and provided on the n⁺ a-Si layer 54, and the overcoat insulating film 101 covering the source electrode 24a and the drain electrode 24b.

Next, as shown in FIG. 10A to FIG. 10D, a transparent conductive film 62 is formed at the parts corresponding to the TFT 2, base part 27, X-coordinate detecting part 25, Y-coordinate detecting part 26 and another base part 27. The conductive film 62 is made of, for example, ITO, and covers the overcoat insulating film 101.

As shown in FIG. 10A, the conductive film 62 is formed, also in the contact hole 101a that exposes the source electrode 24a, and is therefore electrically connected to the source electrode 24a. As shown in FIG. 10C, the conductive film 62 is formed, also in the contact hole 101b exposing the connection part 25b for the X-coordinate detecting part 25, and is therefore electrically connected to the connection part 25b. As shown in FIG. 10D, the conductive film 62 is formed, also in the contact hole 101c exposing the connection part 26b for the Y-coordinate detecting part 26, and is therefore electrically connected to the connection part 26b.

At the time the conductive film 62 is formed, a part of the TFT 2, a part of the base part 27, a part of the X-coordinate detecting part 25, and a part of the Y-coordinate detecting part 26 are simultaneously formed on the first substrate (TFT substrate) as shown in FIG. 10A to FIG. 10D, by the above-mentioned method of forming the TFT 2. Hence, these parts stand on the first substrate (TFT substrate) to the same height.

Next, as shown in FIG. 10B, the part of the base part 27 formed on the conductive film 62 grows, forming a transparent height adjusting part 27a made of, for example, silicon nitride (SiNx) and having a prescribed height. The top of the height adjusting part 27a defines the top surface (distal end) of the base part 27.

Finally, as shown in FIG. 11A, the transparent conductive film 62 is removed, except that part existing in the contact hole 101a and therefore electrically connected to the source electrode 24a, and that part adjacent to the TFT 2 and providing a pixel electrode 1.

Finally, as shown in FIG. 11B, the transparent conductive film 62 is removed, except the part 108 corresponding to the base part 27 and covered with the height adjusting part 27a.

Finally, as shown in FIG. 11C, the transparent conductive film 62 is removed, except the part providing the X-coordinate detecting contact 106 at the X-coordinate detecting part 25 and at the connection part 4b of the X-coordinate detecting line 4, and for the part in which the contact hole 101b is made, electrically connecting the X-coordinate detecting part 25 to the connection part 4b of the X-coordinate detecting line 4.

Finally, as shown in FIG. 11D, the transparent conductive film 62 is removed, except the part providing the Y-coordinate detecting contact 107 at the Y-coordinate detecting part 26 and at the connection part 7b of the Y-coordinate detecting line 7, and for the part in which the contact hole 101c is made, electrically connecting the Y-coordinate detecting part 26 to the connection part 7b of the Y-coordinate detecting line 7.

The parts shown in FIG. 11A to FIG. 11D and corresponding to the TFT2, base part 27, X-coordinate detecting part 25 and Y-coordinate detecting part 26 have the same height measured from the first substrate (TFT substrate) to the top surface (distal end) of the X-coordinate detecting part 25 shown in FIG. 22D, and have the same height measured from the first substrate (TFT substrate) to the top surface (distal end) of the Y-coordinate detecting part 26 shown in FIG. 11D.

The height of the TFT 2 shown in FIG. 11A, measured from the first substrate (TFT substrate) to the top surface (distal end) of the TFT 2 is smaller than the height of the Y-coordinate detecting part 26 shown in FIG. 11D, measured to its top surface (distal end), by the thickness of that part of the Y-coordinate detecting part 26 (FIG. 11D), which has been finally removed at the top surface (distal end).

Moreover, the height measured from the first substrate (TFT substrate) 2 to the top surface (distal end) of the base part 27 is greater than the height measured to the top surface (distal end) of the X-coordinate detecting part 25 (FIG. 11C) and than the height measured to the top surface (distal end) of the Y-coordinate detecting part 26 (FIG. 11D), by the height of the height adjusting part 27a finally formed on the conductive film 62, measured to its top surface (distal end) 27b.

In the first embodiment described above, one data line 3, one X-coordinate detecting line 4 and two data lines 3, for example, are repeatedly arranged in the order mentioned, between the columns of pixel electrodes 1, which are spaced apart in the horizontal direction (X direction). Therefore, each TFT 2 is positioned on the left or right of the associated pixel electrode 1, depending where the one data line 3 and the two data lines 3 are arranged. Any two TFTs 2 arranged on the left and right of one X-coordinate detecting line 4, respectively, can therefore more spaced from each other in the horizontal direction, than the TFTs 2 used in the conventional display shown in FIG. 15. The gap between the two TFTs 2 arranged on the left and right of one X-coordinate detecting line 4, respectively, can be longer than the length of the base part 27 or the total length of the X- and Y-coordinate detecting parts 25 and 26 arranged side by side, all measured in the horizontal direction. That is, a base part 27 and a pair of X- and Y-coordinate detecting parts 25 and 26 can be densely arranged between two TFTs 2 spaced apart in the horizontal direction. As a result, the gap between any two pixel electrodes 1 adjacent in the vertical direction can be shorter than in the conventional display shown in FIG. 15.

That is, the TFTs 2. pairs of X- and Y-coordinate detecting parts 25 and 26 and base parts 27 can be densely arranged in the vertical direction (Y direction). This reduces the intervals at which the pixel electrodes 1 are arranged in the vertical direction (Y direction). As a result, the display 100 can have its aperture ratio increased by the value associated with the increase in the intervals of the pixel electrodes 1. The increased aperture ratio enhances the performance of the display 100, such as display luminance.

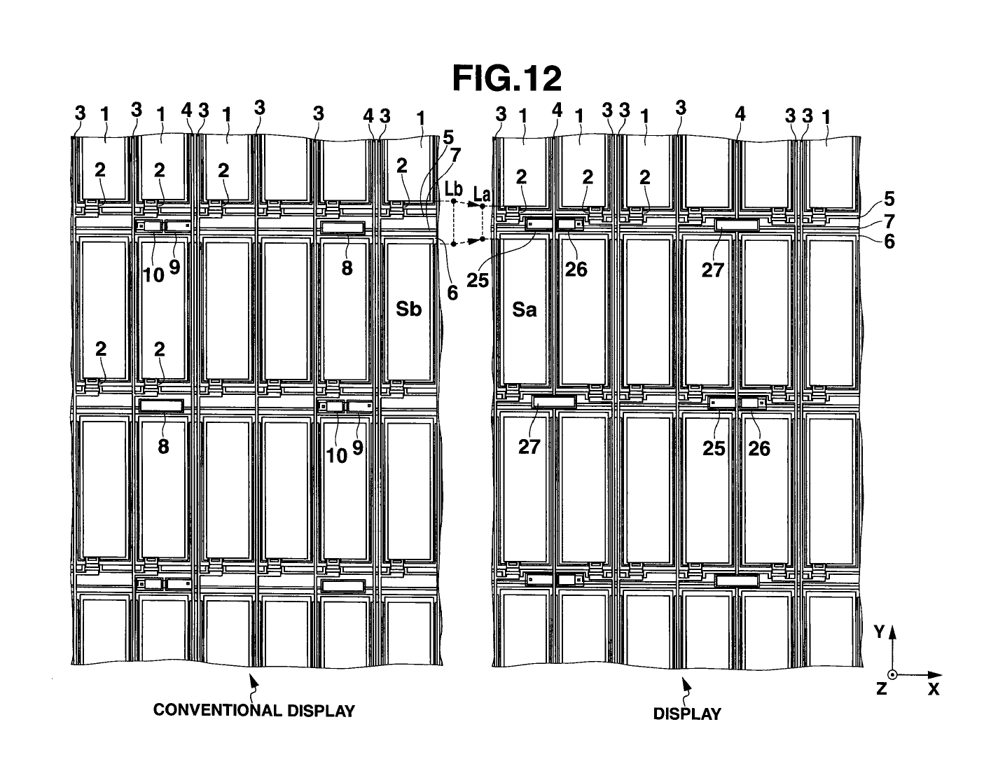

In comparison with the conventional display, the display 100 have pixel electrodes 1 that are arranged, as shown in FIG. 12, in the Y direction at intervals La shorter than the intervals Lb at which the pixel electrodes are arranged in the conventional display. (That is, La<Lb.) Hence, the pixel electrodes 1 of the display 100 can be shorter in the Y direction, than those of the conventional display. Each pixel electrode 1 of the apparatus 100 therefore has area Sa smaller than the area Sb of each pixel electrode 1 of the conventional display. (That is, Sa<Sb.)

Each pixel electrode 1 of the apparatus 100 has the same length in the X direction as each pixel electrode 1 of the conventional display, but is longer in the Y direction than each pixel electrode 1 of the conventional display. This is why each pixel electrode 1 of the apparatus 100 therefore has area Sa smaller than the area Sb of each pixel electrode 1 of the conventional display.

As shown in, for example, FIG. 2, the X-coordinate detecting part 25 and Y-coordinate detecting part 26 of one pair are arranged at the center of a square W having the four corners at four base parts 27. The X-coordinate detecting part 25 and Y-coordinate detecting part 26 are arranged at positions where the counter electrode 20 is bent most greatly when the user touches the display 100. That is, the position where the largest bending force is applied is that part of the counter electrode 20, which may be bent most. If pressed only a little, any pair of X- and Y-coordinate detecting parts 25 and 26 can generate an XY coordinate signal. Thus, the X-coordinate detecting part 25 and the Y-coordinate detecting part 26 can detect an X coordinate and a Y coordinate, respectively, with high sensitivity.

### Second Embodiment

A second embodiment of this invention will be described with reference to the accompanying drawings.

The components identical to those shown in FIG. 2 are designated by the same reference numbers and will not be described in detail.

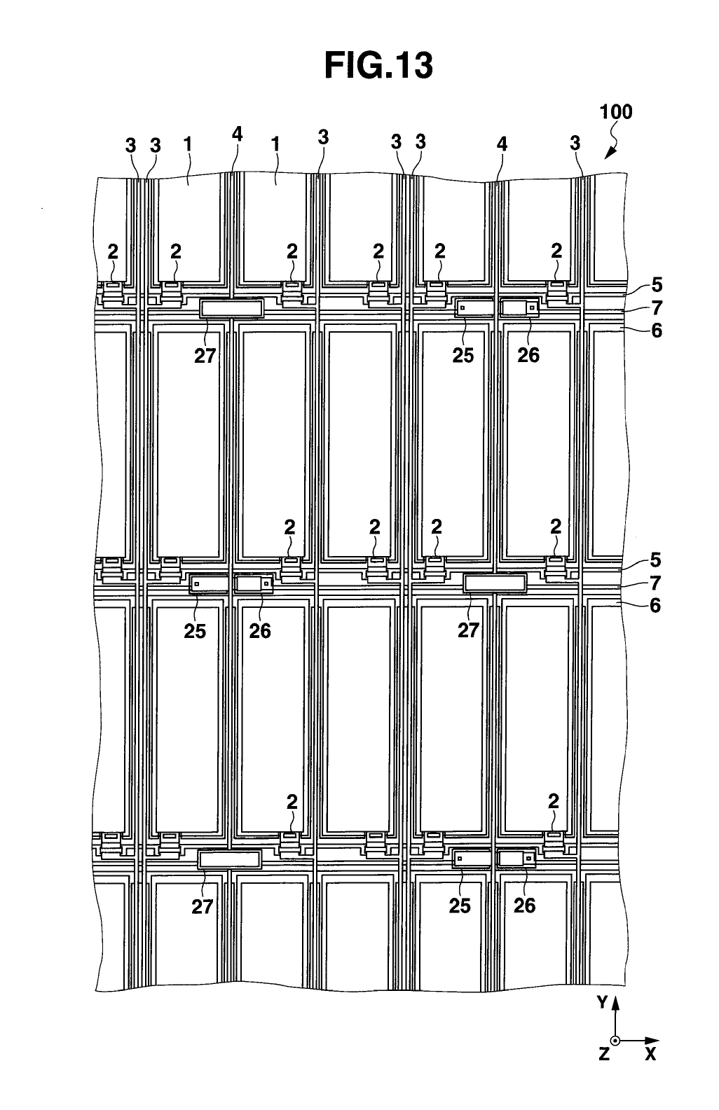

FIG. 13 is a configuration diagram showing a second embodiment of the display according to this invention, which also has a touch panel function. In this display 100, two data line 3, one X-coordinate detecting line 4, one data line 3 are repeatedly arranged in the order mentioned, from the left to the right, between any three pixel electrodes 1 adjacent in the X direction.

Since two data line 3, one X-coordinate detecting line 4, one data line 3 are repeatedly arranged in this manner, any two TFTs 2 arranged on the left and right of one X-coordinate detecting line 4 can be spaced more in the X direction, than in the conventional display shown in FIG. 15. In the gap between any two TFTs 2 adjacent in the X direction, a pair of X- and Y-coordinate detecting parts 25 and 26 and a base part 27 can be densely arranged in the Y direction. The intervals at which pixel electrodes 1 are arranged in the Y direction can therefore be shortened.

As a result, the display 100 can have its aperture ratio increased by the value associated with the decrease in the intervals of the pixel electrodes 1. The increased aperture ratio enhances the performance of the display 100, such as display luminance, as in the first embodiment.

### Third Embodiment

A third embodiment of this invention will be described with reference to the accompanying drawings. The components identical to those shown in FIG. 2 are designated by the same reference numbers and will not be described in detail.

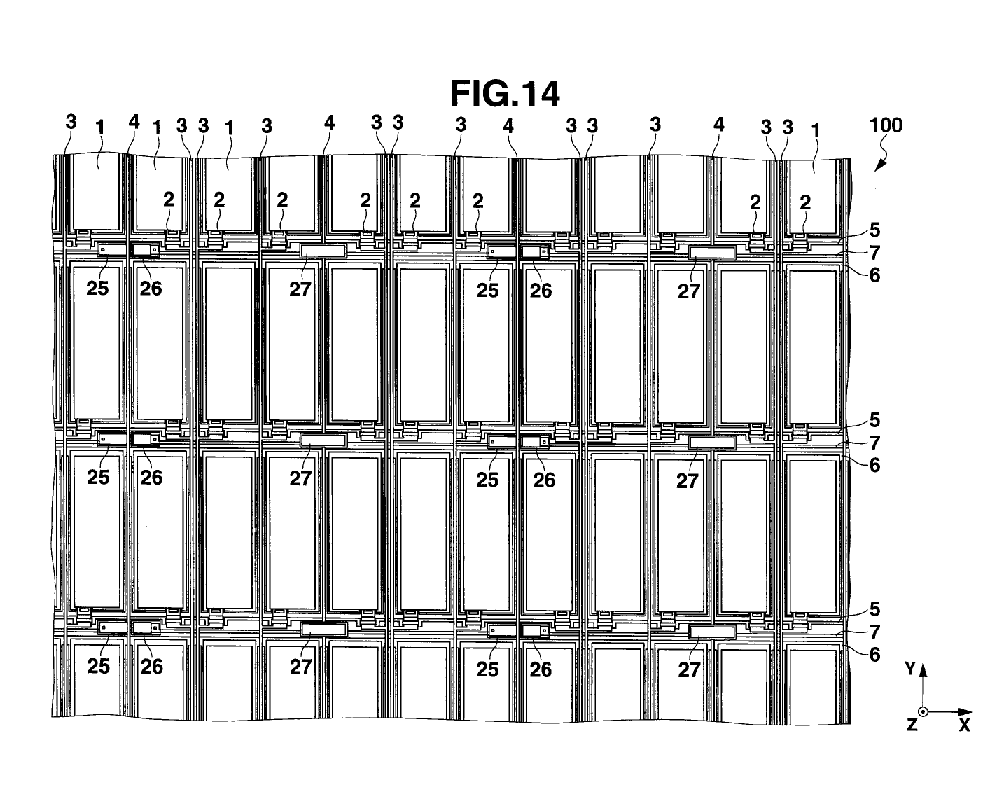

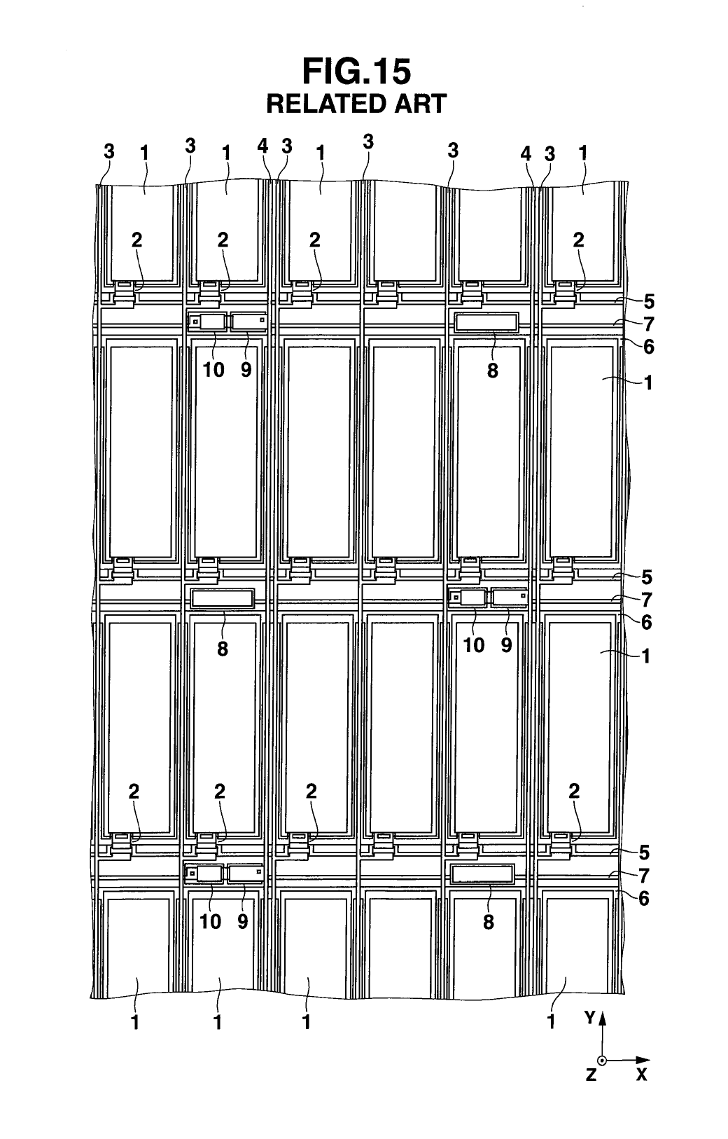

FIG. 14 is a configuration diagram showing a third embodiment of the display according to this invention, which also has a touch panel function. In this display 100, one data line 3, one X-coordinate detecting line 4, two data line 3 are repeatedly arranged in the order mentioned, from the left to the right, between any three pixel electrodes 1 adjacent in the X direction.

In this display 100, a pair of X- and Y-coordinate detecting parts 25 and 26 is arranged on one X-coordinate detecting line 4 extending in the Y direction. In addition, base parts 27 are arranged on each X-coordinate detecting line 4 extending in the Y direction. Pairs of X- and Y-coordinate detecting parts 25 and 26 and base parts 27 are alternately arranged in the X direction, one pair of X- and Y-coordinate detecting parts 25 and 26 and one base part 27 for every three pixel electrodes 1 adjacent in the X direction.

In this configuration, any two TFTs 2 arranged on the left and right of one X-coordinate detecting line 4 can be spaced more in the X direction, than in the conventional display shown in FIG. 15. In the gap between any two TFTs 2 adjacent in the X direction, a pair of X- and Y-coordinate detecting parts 25 and 26 and a base part 27 can be densely arranged in the Y direction. The intervals at which pixel electrodes 1 are arranged in the Y direction can therefore be shortened.

As a result, the display 100 can have its aperture ratio increased. The increase in the aperture ratio enhances the performance of the display 100, such as display luminance, as in the first embodiment.

The present invention is not limited to the embodiments described above. The components of any embodiment can be modified in various manners in reducing the invention to practice, without departing from the spirit or scope of the invention. Further, the components of any embodiment described above may be combined, if necessary, in various ways to make different inventions. For example, some of the component of any embodiment may not be used. Moreover, the components of the different embodiments may be combined in any desired fashion.

What is claimed is:

1. A display apparatus comprising:
a plurality of pixel electrodes arranged in a first direction and a second direction different from the first direction;
a counter electrode arranged, facing to the plurality of pixel electrodes;
a plurality of pixel transistors connected to the plurality of the pixel electrodes, respectively;
a plurality of first coordinate detecting lines arranged in the first direction;
a plurality of second coordinate detecting lines arranged in the second direction;
a plurality of signal lines arranged in the second direction and configured to supply display signals to the plurality of pixel transistors;
a plurality of first coordinate detecting parts, each having a first contact, connected to the plurality of first coordinate detecting lines, respectively, and each configured to electrically connect one first coordinate detecting line to the counter electrode if the first contact touches the counter electrode upon receiving an external pressure; and
a plurality of second coordinate detecting parts, each having a second contact, connected to the plurality of second coordinate detecting lines, respectively, and each configured to electrically connect one second coordinate detecting line to the counter electrode if the second contact touches the counter electrode upon receiving the pressure,
wherein each second coordinate detecting line is arranged between the second and third of every four pixel electrodes continuously arranged in the first direction;
two signal lines are arranged between the first and second pixel electrodes or between the third and fourth pixel electrodes;
the pixel transistor are connected to the second and third pixel electrodes, respectively, facing each other across one second coordinate detecting line, and arranged far from the second coordinate detecting line; and
the first coordinate detecting part and the second coordinate detecting part are arranged between two pixel transistors connected to the second and third pixel electrodes, respectively.

2. The display apparatus according to claim 1,
wherein each first coordinate detecting part and each second coordinate detecting part are arrange, forming a pair.

3. The display apparatus according to claim 2,
wherein the pixel transistor connected to the second pixel electrode and the pixel transistor connected to the third pixel electrode is spaced by a gap longer than the total length of the first and second coordinate detecting parts of the pair, the total length measured in the first direction.

4. The display apparatus according to claim 2,
wherein the first and second coordinate detecting parts of the pair are arranged on one first coordinate detecting line.

5. The display apparatus according to claim 1, further comprising:
a plurality of scanning lines configured to supply scanning signals to the pixel transistors, respectively,
wherein each scanning line is arranged between one pixel electrode and one first coordinate detecting line and includes an extension protruding toward the first coordinate detecting line, and
each pixel transistor uses the extension as gate electrode.

6. The display apparatus according to claim 1, further comprising:
a liquid crystal layer sealed between each pixel electrode and the counter electrode.

7. The display apparatus according to claim 1, further comprising:
electrophoretic particles electrically charged and sealed between each pixel electrode and the counter electrode.

8. The display apparatus according to claim 1, further comprising:
spacers providing a gap between each first coordinate detecting part and the counter electrode and a gap between each second coordinate detecting part and the counter electrode; and
a plurality of base parts, each providing a prescribed gap between the first contact and the counter electrode and between the second contact and the counter electrode while the pressure is not being applied,
wherein each second coordinate detecting line is arranged between the sixth and seventh of the fifth to eighth pixel electrodes continuously arranged in the first direction;
two signal lines are arranged between the fifth and sixth pixel electrodes or between the seventh and eighth pixel electrodes;
each pixel transistor is connected to the sixth and seventh pixel electrodes, respectively, and arranged on sides of each second coordinate detecting line and far from the second coordinate detecting line; and
each base part is arranged between two pixel transistors connected to the sixth pixel and seventh pixel electrodes, respectively.

9. The display apparatus according to claim 8,
wherein the pixel transistor connected to the sixth pixel electrode and the pixel transistor connected to the seventh pixel electrode are spaced by a gap longer than the length of the base part, which is measured in the first direction.

10. The display apparatus according to claim 8,
wherein the base parts are arranged on each first coordinate detecting line.

11. The display apparatus according to claim 8, further comprising:
a plurality of scanning lines configured to supply scanning signals to the pixel transistors, respectively,
wherein each scanning line is arranged between one pixel electrode and one first coordinate detecting line and includes an extension protruding toward the first coordinate detecting line, and each pixel transistor uses the extension as gate electrode.

12. The display apparatus according to claim 8,
wherein one signal line, one second coordinate detecting line and two signal lines, or two signal lines, one second coordinate detecting line and one signal line are repeatedly arranged between those of the pixel electrodes, which are continuously arranged in the first direction.

13. The display apparatus according to claim 12,
wherein each first coordinate detecting part and each second coordinate detecting part form a pair and arranged in the first direction, at every other intersections of the first and second coordinate detecting lines, whereby pairs of first and second coordinate detecting parts on one row are staggered, in the first direction, from the pairs of first and second coordinate detecting parts on the next row; and
the base parts are arranged in the first direction and at the intersections other than those at which the first and second coordinate detecting parts are arranged.

14. The display apparatus according to claim 13,
wherein each first coordinate detecting part and each second coordinate detecting part are arranged at positions where the counter electrode is bent most greatly upon receiving the pressure.

15. The display apparatus according to claim 12,
wherein each first coordinate detecting part and each second coordinate detecting part form a pair and arranged in the first direction, at every other intersections of the first and second coordinate detecting lines, and arranged in the second direction, at every intersection of the first and second coordinate detecting lines; and
the base parts are arranged in the first direction and at the intersections other than those at which the first and second coordinate detecting parts are arranged, respectively.

16. The display apparatus according to claim 15,
wherein each first coordinate detecting part and each second coordinate detecting part are arranged at positions where the counter electrode is bent most greatly upon receiving the pressure.

17. A display apparatus comprising:
a plurality of pixel electrodes arranged in a first direction and a second direction different from the first direction;
a counter electrode arranged, facing to the plurality of pixel electrodes;
a plurality of pixel transistors connected to the plurality of the pixel electrodes, respectively;
a plurality of first coordinate detecting lines arranged in the first direction;
a plurality of second coordinate detecting lines arranged in the second direction;
a plurality of signal lines arranged in the second direction and configured to supply display signals to the plurality of pixel transistors;
a plurality of first coordinate detecting parts, each having a first contact, connected to the plurality of first coordinate detecting lines, respectively, and each configured to electrically connect one first coordinate detecting line to the counter electrode if the first contact touches the counter electrode upon receiving an external pressure; and
a plurality of second coordinate detecting parts, each having a second contact, connected to the plurality of second coordinate detecting lines, respectively, and each configured to electrically connect one second coordinate detecting line to the counter electrode if the second contact touches the counter electrode upon receiving the pressure; and
a plurality of base parts, each including a spacer maintaining a gap between each first coordinate detecting part and the counter electrode and a gap between each second coordinate detecting part and the counter electrode, and each setting a gap between the first contact and the counter electrode and a gap between the second contact and the counter electrode to a prescribed contact gap, while the counter electrode is not receiving the pressure,
wherein each second coordinate detecting line is arranged between the second and third of every four pixel electrodes continuously arranged in the first direction;
two signal lines are arranged between the first and second pixel electrodes or between the third and fourth pixel electrodes, and one signal line is arranged between the remaining two pixel electrodes; two pixel transistor are connected to the second and third pixel electrodes, facing each other across one second coordinate detecting line, and arranged far from the second coordinate detecting line; and
the base parts or the first coordinate detecting part and the second coordinate detecting part, are arranged between two pixel transistors connected to the second and third pixel electrodes, respectively.

18. The display apparatus according to claim 17,
wherein the pixel transistor connected to the second pixel electrode and the pixel transistor connected to the third pixel electrode is spaced by a gap longer than the total length of the first and second coordinate detecting parts of the pair, the total length measured in the first direction.

19. The display apparatus according to claim 18, further comprising:
a liquid crystal layer sealed between each pixel electrode and the counter electrode.

20. The display apparatus according to claim 18, further comprising:
electrophoretic particles electrically charged and sealed between each pixel electrode and the counter electrode.
